(19) United States
(12) Patent Application Publication
(10) Pub. No.: US 2021/0185314 A1
(43) Pub. Date: Jun. 17, 2021

(54) IMAGE DECODING DEVICE, IMAGE CODING DEVICE, IMAGE PROCESSING SYSTEM, AND PROGRAM

(71) Applicant: KDDI CORPORATION, Tokyo (JP)

(72) Inventors: Yoshitaka KIDANI, Fujimino-shi (JP); Kei KAWAMURA, Fujimino-shi (JP); Kyohei UNNO, Fujimino-shi (JP); Haruhisa KATO, Fujimino-shi (JP); Sei NAITO, Fujimino-shi (JP)

(73) Assignee: KDDI CORPORATION, Tokyo (JP)

(21) Appl. No.: 17/184,077

(22) Filed: Feb. 24, 2021

Related U.S. Application Data
(63) Continuation of application No. PCT/JP2019/030887, filed on Aug. 6, 2019.

(30) Foreign Application Priority Data
Sep. 21, 2018 (JP) 2018-178102

(51) Int. Cl. H04N 19/117; H04N 19/80; H04N 19/105; H04N 19/176

(52) U.S. Cl. CPC H04N 19/117; H04N 19/176; H04N 19/105; H04N 19/80

(57) ABSTRACT

An image decoding device includes a circuit that generates a prediction signal included in a prediction block based on a reference signal included in a reference block. The circuit includes an interpolation filter that generates an interpolation signal of a decimal reference pixel included in the reference block from a reference signal of an integer reference pixel included in the reference block. The circuit selects a type of the interpolation filter based on a block size of the prediction block and a quantization parameter of the prediction block.

### CROSS-REFERENCE TO RELATED APPLICATIONS

The present application is a continuation based on PCT Application No. PCT/JP2019/030887, filed on Aug. 6, 2019, which claims the benefit of Japanese patent application No. 2018-178102 filed on Sep. 21, 2018. The content of which is incorporated by reference herein in their entirety.

### TECHNICAL FIELD

The present invention relates to an image decoding device, an image coding device, an image processing system, and a program.

### BACKGROUND

Conventionally, there has been proposed a technique in which a prediction residual signal that is the difference between a prediction signal generated by intra-prediction (intra-frame prediction) or inter-prediction (inter-frame prediction) and an input image signal is generated, and a transform process and a quantization process are performed on the prediction residual signal (for example, HEVC; High Efficiency Video Coding) (for example, ITU-T H.265 High Efficiency Video Coding).

There has also been proposed a technique in which when a reference signal used to generate a prediction signal is generated in such an image processing technique, an interpolated pixel generated from an integer reference pixel is used as the reference signal (for example, JP 5711098 B1).

### SUMMARY

In the image processing techniques described above, the tap length of an interpolation filter used for an interpolated pixel is selected according to the block size and quantization parameter of a prediction block.

However, the type of the interpolation filter is not considered in the image processing techniques described above, and thus there is still a need for improving coding efficiency.

The present invention has been made in order to solve the above problems, and an object of the present invention is to provide an image decoding device, an image coding device, an image processing system, and a program that can improve the coding efficiency.

An image decoding device according to the first feature includes a circuit that generates a prediction signal included in a prediction block based on a reference signal included in a reference block. The circuit includes an interpolation filter that generates an interpolation signal of a decimal reference pixel included in the reference block from a reference signal of an integer reference pixel included in the reference block. The circuit selects a type of the interpolation filter based on a block size of the prediction block and a quantization parameter of the prediction block.

An image coding device according to the second aspect includes a circuit that generates a prediction signal included in a prediction block based on a reference signal included in a reference block. The circuit includes an interpolation filter that generates an interpolation signal of a decimal reference pixel included in the reference block from a reference signal of an integer reference pixel included in the reference block. The circuit selects a type of the interpolation filter based on a block size of the prediction block and a quantization parameter of the prediction block.

An image processing system according to the third feature includes an image coding device and an image decoding device. The image coding device and the image decoding device include a circuit that generates a prediction signal included in a prediction block based on a reference signal included in a reference block. The circuit includes an interpolation filter that generates an interpolation signal of a decimal reference pixel included in the reference block from a reference signal of an integer reference pixel included in the reference block. The circuit selects a type of the interpolation filter based on a block size of the prediction block and a quantization parameter of the prediction block.

A program according to the fourth feature causes a computer to perform a prediction step of generating a prediction signal included in a prediction block based on a reference signal included in a reference block. The prediction step includes a step of selecting an interpolation filter that generates an interpolation signal of a decimal reference pixel included in the reference block from a reference signal of an integer reference pixel included in the reference block based on a block size of the prediction block and a quantization parameter of the prediction block.

According to one aspect, it is possible to provide an image decoding device, an image coding device, an image processing system, and a program that can improve the coding efficiency.

### BRIEF DESCRIPTION OF DRAWINGS

FIG. 1 is a diagram illustrating an image processing system 10 according to an embodiment.

FIG. 2 is a diagram illustrating an image coding device 100 according to the embodiment.

FIG. 3 is a diagram illustrating an intra-prediction unit 112 in the embodiment.

FIG. 4 is a view for explaining a reference pixel in the embodiment.

FIG. 5 is a table for explaining a method of selecting an interpolation filter type in the embodiment.

FIG. 6 is a diagram illustrating an image decoding device 200 according to the embodiment.

FIG. 7 is a diagram illustrating an intra-prediction unit 242 in the embodiment.

FIG. 8 is a table for explaining a method of selecting the type and tap length of an interpolation filter in a first modification.

FIG. 9 is a table for explaining a method of selecting the type and tap length of an interpolation filter in a second modification.

FIG. 10 is a view for explaining a method of selecting the type of an interpolation filter in a third modification.

FIG. 11 is a view for explaining a method of selecting the type and tap length of an interpolation filter in a fourth modification.

FIG. 12 is a view for explaining a method of selecting the type and tap length of an interpolation filter in a fourth modification.

FIG. 13 is a table for explaining the applicability of a smoothing filter in a sixth modification.

### DETAILED DESCRIPTION

Hereinafter, embodiments will be described with reference to the drawings. It should be noted that in the following description of the drawings, the same or similar parts are denoted by the same or similar reference numerals.

However, it is to be noted that the drawings are schematic and the ratio of the respective dimensions may differ from the actual one. Consequently, the specific dimensions and the like should be determined in consideration of the following description. In addition, it goes without saying that in some cases, the drawings include parts having different dimensional relationships or ratios from each other.

An image decoding device according to a summary of disclosure includes a prediction unit (circuit) that generates a prediction signal included in a prediction block based on a reference signal included in a reference block. The prediction unit includes an interpolation filter that generates an interpolation signal of a decimal reference pixel included in the reference block from a reference signal of an integer reference pixel included in the reference block. The prediction unit selects a type of the interpolation filter based on a block size of the prediction block and a quantization parameter of the prediction block.

In the image decoding device according to a summary of disclosure, a type of the interpolation filter is selected based on a block size of the prediction block and a quantization parameter of the prediction block. According to such a configuration, it is possible to improve the coding efficiency.

An image coding device according to a summary of disclosure includes a prediction unit that generates a prediction signal included in a prediction block based on a reference signal included in a reference block. The prediction unit includes an interpolation filter that generates an interpolation signal of a decimal reference pixel included in the reference block from a reference signal of an integer reference pixel included in the reference block. The prediction unit selects a type of the interpolation filter based on a block size of the prediction block and a quantization parameter of the prediction block.

In the image coding device according to a summary of disclosure, a type of the interpolation filter is selected based on a block size of the prediction block and a quantization parameter of the prediction block. According to such a configuration, it is possible to improve the coding efficiency.

As the summary of the disclosure, an image decoding method related to the operation of the image decoding device described above may be provided, or an image coding method related to the operation of the image coding device described above may be provided. As the summary of the disclosure, an image processing system having the image decoding device and the image coding device that are described above may be provided. As the summary of the disclosure, a program related to the operation of the image decoding device described above may be provided, or a program related to the operation of the image coding device described above may be provided.

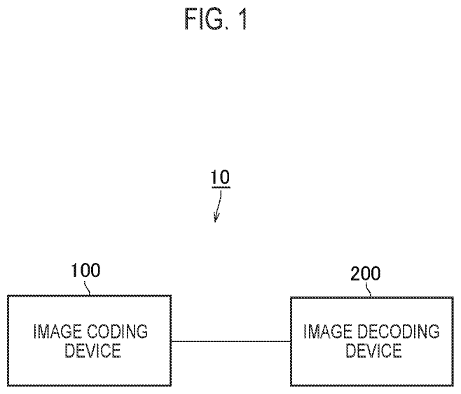

Hereinafter, an image processing system according to an embodiment will be described. FIG. 1 is a diagram illustrating an image processing system 10 according to the embodiment.

As illustrated in FIG. 1, the image processing system 10 includes an image coding device 100 and an image decoding device 200. The image coding device 100 codes an input image signal to generate coded data. The image decoding device 200 decodes the coded data to generate an output image signal. The coded data may be transmitted from the image coding device 100 to the image decoding device 200 through a transmission line. The coded data may be stored in a storage medium and then provided to the image decoding device 200 from the image coding device 100.

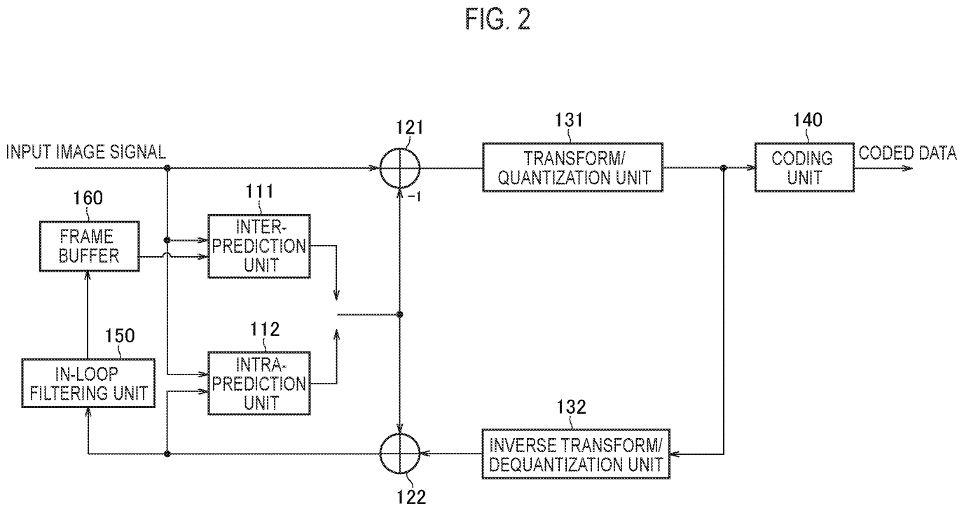

Hereinafter, the image coding device according to the embodiment will be described. FIG. 2 is a diagram illustrating the image coding device 100 according to the embodiment.

As illustrated in FIG. 2, the image coding device 100 includes an inter-prediction unit 111, an intra-prediction unit 112, a subtractor 121, an adder 122, a transform/quantization unit 131, an inverse transform/dequantization unit 132, a coding unit 140, an in-loop filtering unit 150, and a frame buffer 160.

The inter-prediction unit 111 generates a prediction signal by inter-prediction (inter-frame prediction). Specifically, the inter-prediction unit 111 compares a coding target frame (hereinafter, referred to as “target frame”) with a reference frame stored in the frame buffer 160 to specify a reference block included in the reference frame, and then determines the motion vector of the reference block specified. The inter-prediction unit 111 generates a prediction signal included in a prediction block for each prediction block, based on the reference block and the motion vector. The inter-prediction unit 111 outputs the prediction signal to the subtractor 121 and the adder 122. The reference frame is different from the target frame.

The intra-prediction unit 112 generates a prediction signal by intra prediction (intra-frame prediction). Specifically, the intra-prediction unit 112 specifies a reference block included in a target frame, and generates the prediction signal for each prediction block based on the reference block specified. The intra-prediction unit 112 outputs the prediction signal to the subtractor 121 and the adder 122. The reference block is referred to in terms of a prediction target block (hereinafter, referred to as target block). For example, the reference block is adjacent to the target block.

The subtractor 121 subtracts a prediction signal from an input image signal, and outputs a prediction residual signal to the transform/quantization unit 131. Here, the subtractor 121 generates the prediction residual signal that is the difference between the prediction signal generated by the intra-prediction or inter-prediction and the input image signal.

The adder 122 adds a prediction signal to a prediction residual signal output from the inverse transform/dequantization unit 132, and outputs a pre-filtering decoded signal to the intra-prediction unit 112 and the in-loop filtering unit 150. The pre-filtering decoded signal configures the reference block that is used in the intra-prediction unit 112.

The transform/quantization unit 131 performs a transformation process on a prediction residual signal, and also acquires a coefficient level value. Further, the transform/quantization unit 131 may quantize the coefficient level value. In the transformation process, the prediction residual signal is transformed into a frequency component signal. In the transformation process, the base pattern (transformation matrix) corresponding to the discrete cosine transform (DCT) may be used, or the base pattern (transformation matrix) corresponding to the discrete sine transform (DST) may be used.

The inverse transform/dequantization unit 132 performs an inverse transformation process on a coefficient level value output from the transform/quantization unit 131. Here, the inverse transform/dequantization unit 132 may perform the dequantization of the coefficient level value prior to the inverse transformation process. The inverse transformation process and the dequantization are performed in the reverse procedure of the transformation process and the quantization performed by the transform/quantization unit 131.

The coding unit 140 codes a coefficient level value output from the transform/quantization unit 131 and outputs coded data. For example, coding is entropy coding in which assigns codes of different lengths are assigned based on the probability of occurrence of a coefficient level value.

The coding unit 140 codes not only the coefficient level value but also control data that is used in a decoding process. The control data may include size data such as a coded block size, a prediction block size, and a transform block size.

The in-loop filtering unit 150 performs filtering on a pre-filtering decoded signal output from the adder 122, and outputs a filtered decoded signal to the frame buffer 160. For example, filtering is deblocking filtering that reduces distortions at the boundary portion of a block (coded block, prediction block, or transform block).

The frame buffer 160 accumulates a reference frame that is used in the inter-prediction unit 111. The filtered decoded signal configures the reference frame that is used in the inter-prediction unit 111.

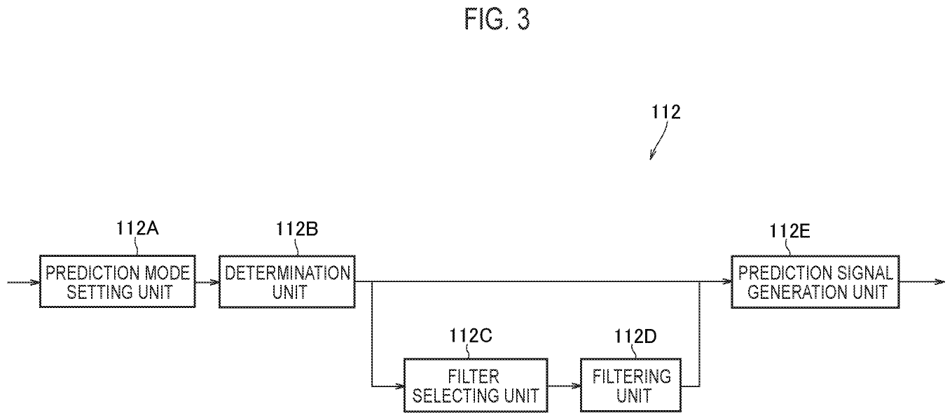

Hereinafter, the intra-prediction unit of the embodiment will be described. FIG. 3 is a diagram illustrating the intra-prediction unit 112 in the embodiment. The intra-prediction unit 112 is an example of a prediction unit that generates a prediction signal included in a prediction block based on a reference signal included in a reference block.

As illustrated in FIG. 3, the intra-prediction unit 112 includes a prediction mode setting unit 112A, a determination unit 112B, a filter selecting unit 112C, a filtering unit 112D, and a prediction signal generation unit 112E.

The prediction mode setting unit 112A sets an intra-prediction mode in which the prediction signal is generated. Examples of the intra-prediction mode include a DC (Direct Current) prediction mode, a planar prediction mode, and a directional prediction mode. The directional prediction mode includes a horizontal prediction mode in which the prediction signal is generated from a reference signal of a reference pixel located horizontally to a prediction pixel, a vertical prediction mode in which the prediction signal is generated from a reference signal of a reference pixel located vertically to a prediction pixel, and a diagonal prediction mode in which the prediction signal is generated from a reference signal of a reference pixel located diagonally to a prediction pixel.

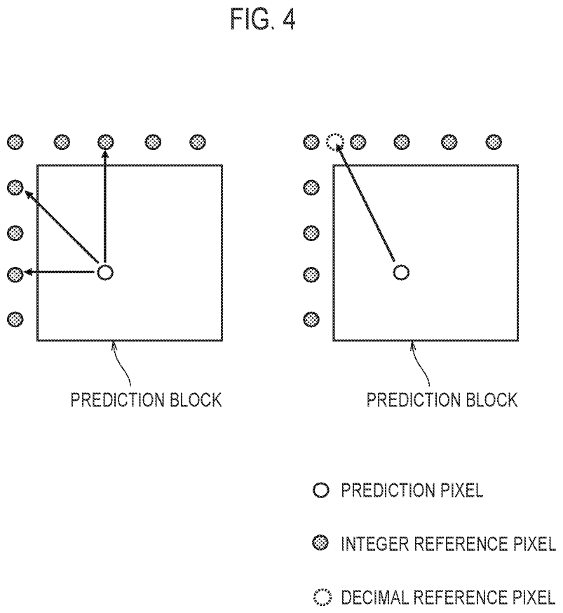

As illustrated in FIG. 4, reference pixels used in the horizontal prediction mode and the vertical prediction mode are integer reference pixels. Meanwhile, the reference pixel in the diagonal prediction mode is an integer reference pixel in one case, and is a decimal reference pixel in the other case. The integer reference pixel and the decimal reference pixel are both reference pixels included in a reference block.

The determination unit 112B determines whether or not the decimal reference pixel needs to be used based on the intra-prediction mode. When the intra-prediction mode is the DC prediction mode, the planar prediction mode, the horizontal prediction mode, or the vertical prediction mode, the determination unit 112B determines that the decimal reference pixel does not need to be used, and notifies the prediction signal generation unit 242E of the intra-prediction mode.

When the intra-prediction mode is the diagonal prediction mode and the reference pixel is the integer reference pixel, the determination unit 112B determines that the decimal reference pixel does not need to be used, and notifies the prediction signal generation unit 242E of the intra-prediction mode. On the other hand, when the intra-prediction mode is the diagonal prediction mode and the reference pixel is the decimal reference pixel, the determination unit 112B determines that the decimal reference pixel needs to be used, and notifies the filter selecting unit 112C of the intra-prediction mode.

The filter selecting unit 112C selects an interpolation filter type based on the block size and quantization parameter of a prediction block. For example, a linear filter, a cubic filter, and a Gaussian filter can be used as the interpolation filter. The cubic filter has higher smoothness than the linear filter. The Gaussian filter has higher smoothness than the cubic filter.

The block size may be the number of horizontal pixels in a prediction block, or may be the number of vertical pixels in the prediction block. The block size may be the smaller one of the number of the horizontal pixels and the number of the vertical pixels. The quantization parameter is used to quantize a coefficient level value. The smaller the quantization parameter, the lower the image compression rate and the higher the image quality.

Hereinafter, the cubic filter is exemplified as the interpolation filter with low smoothness, and the Gaussian filter is exemplified as the interpolation filter with high smoothness.

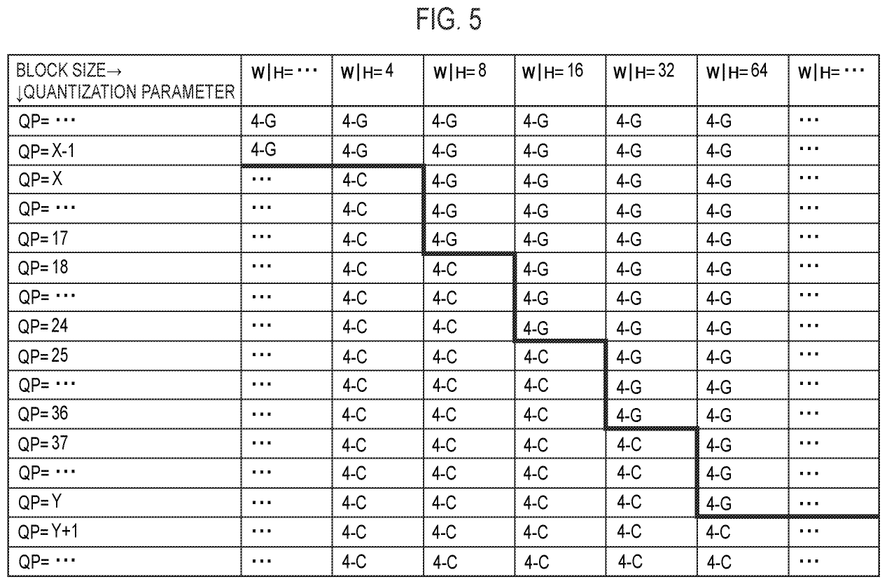

As illustrated in FIG. 5, as the quantization parameter increases, the filter selecting unit 112C increases the chance to select the cubic filter with low smoothness as the interpolation filter. Increasing the chance means increasing the number of block sizes for which the cubic filter is selected. As the block size increases, the filter selecting unit 112C increases the chance to select the Gaussian filter with high smoothness as the interpolation filter. Increasing the chance means increasing the number of quantization parameters for which the Gaussian filter is selected.

In FIG. 5, “4-G” means a Gaussian filter with a tap length of 4. “4-C” means a cubic filter with a tap length of 4.

When one of the block size and the quantization parameter satisfies a predetermined condition, the filter selecting unit 112C fixes the interpolation filter type without changing the interpolation filter type. For example, the predetermined condition is at least one of the condition that the quantization parameter is smaller than a first threshold (X in FIG. 5) and the condition that the quantization parameter is larger than a second threshold (Y in FIG. 5). Specifically, when the quantization parameter is smaller than X, the filter selecting unit 112C may select the Gaussian filter without depending on the block size. When the quantization parameter is larger than Y, the filter selecting unit 112C may select the cubic filter without depending on the block size.

The filtering unit 112D includes an interpolation filter that generates an interpolation signal of a decimal reference pixel from a reference signal of an integer reference pixel. The filtering unit 112D generates the interpolation signal of the decimal reference pixel using the interpolation filter selected by the filter selecting unit 112C. The filtering unit 112D may apply the interpolation filter with the tap length selected by the filter selecting unit 112C.

The prediction signal generation unit 112E generates a prediction signal of a target pixel from a reference signal of a reference pixel based on the intra-prediction mode. When the reference pixel is an integer reference pixel, the prediction signal generation unit 112E generates the prediction signal based on the reference signal (pre-filtering decoded signal) of the integer reference pixel output from the adder 122. When the reference pixel is a decimal reference pixel, the prediction signal generation unit 112E generates the prediction signal based on the reference signal of the decimal reference pixel generated by the filtering unit 113.

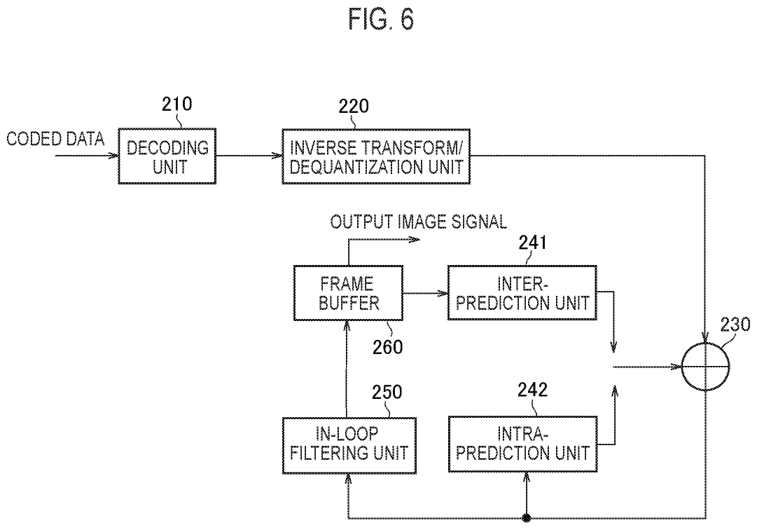

Hereinafter, the image decoding device according to the embodiment will be described. FIG. 6 is a diagram illustrating the image decoding device 200 according to the embodiment.

As illustrated in FIG. 6, the image decoding device 200 includes a decoding unit 210, an inverse transform/dequantization unit 220, an adder 230, an inter-prediction unit 241, an intra-prediction unit 242, an in-loop filtering unit 250, and a frame buffer 260.

The decoding unit 210 decodes the coded data generated by the image coding device 100 to decode a coefficient level value. For example, decoding is entropy decoding performed in the reverse procedure of the entropy coding performed by the coding unit 140.

The decoding unit 210 may acquire control data by the decoding process of the coded data. As described above, the control data may include size data such as a coded block size, a prediction block size, and a transform block size. The control data may include an information element indicating an input source used to generate a prediction sample of a second component.

The inverse transform/dequantization unit 220 performs an inverse transformation process on a coefficient level value output from the decoding unit 210. Here, the inverse transform/dequantization unit 220 may perform the dequantization of the coefficient level value prior to the inverse transformation process. The inverse transformation process and the dequantization are performed in the reverse procedure of the transformation process and the quantization performed by the transform/quantization unit 131.

The adder 230 adds a prediction signal to a prediction residual signal output from the inverse transform/dequantization unit 220, and outputs a pre-filtering decoded signal to the intra-prediction unit 242 and the in-loop filtering unit 250. The pre-filtering decoded signal configures the reference block that is used in the intra-prediction unit 242.

The inter-prediction unit 241 generates a prediction signal by inter-prediction (inter-frame prediction), similarly to the inter-prediction unit 111. Specifically, the inter-prediction unit 241 generates the prediction signal for each prediction block, based on a motion vector decoded from coded data and a reference signal included in a reference frame. The inter-prediction unit 241 outputs the prediction signal to the adder 230.

The intra-prediction unit 242 generates a prediction signal by intra-prediction (intra-frame prediction), similarly to the intra-prediction unit 112. Specifically, the intra-prediction unit 242 specifies a reference block included in a target frame, and generates the prediction signal for each prediction block based on the reference block specified. The intra-prediction unit 242 outputs the prediction signal to the adder 230.

The in-loop filtering unit 250 performs filtering on a pre-filtering decoded signal output from the adder 230 similarly to the in-loop filtering unit 150, and outputs a filtered decoded signal to the frame buffer 260. For example, filtering is deblocking filtering that reduces distortions at the boundary portion of a block (coded block, prediction block, or transform block).

The frame buffer 260 accumulates a reference frame that is used in the inter-prediction unit 241, similarly to the frame buffer 160. The filtered decoded signal configures the reference frame used in the inter-prediction unit 241.

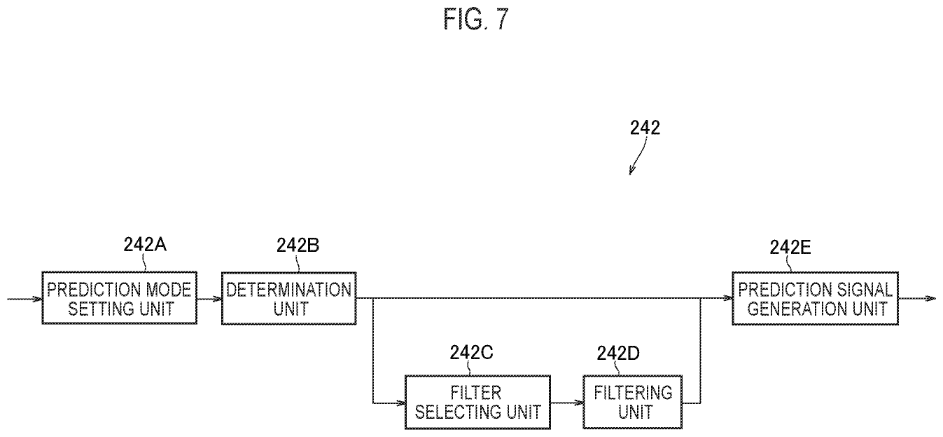

Hereinafter, the intra-prediction unit of the embodiment will be described. FIG. 7 is a diagram illustrating the intra-prediction unit 242 in the embodiment. The intra-prediction unit 242 is an example of the prediction unit that generates a prediction signal included in a prediction block based on a reference signal included in a reference block.

As illustrated in FIG. 7 the intra-prediction unit 242 includes a prediction mode setting unit 242A, a determination unit 242B, a filter selecting unit 242C, a filtering unit 242D, and a prediction signal generation unit 242E.

The prediction mode setting unit 242A sets an intra-prediction mode in which the prediction signal is generated, similarly to the prediction mode setting unit 112A.

The determination unit 242B determines whether or not the decimal reference pixel needs to be used based on the intra-prediction mode, similarly to the determination unit 112B.

The filter selecting unit 242C selects an interpolation filter type based on the block size and quantization parameter of a prediction block, similarly to the filter selecting unit 112C.

The filtering unit 242D includes an interpolation filter that generates an interpolation signal of a decimal reference pixel from a reference signal of an integer reference pixel, similarly to the filtering unit 112D. The filtering unit 242D generates the interpolation signal of the decimal reference pixel using the interpolation filter selected by the filter selecting unit 242C.

The prediction signal generation unit 242E generates a prediction signal of a target pixel from a reference signal of a reference pixel based on the intra-prediction mode, similarly to the prediction signal generation unit 112E.

In the image coding device 100 and the image decoding device 200 according to the summary of the disclosure, the interpolation filter type is selected based on the block size and quantization parameter of a prediction block. With such a configuration, the coding efficiency can be improved.

Specifically, as a result of diligent study, the inventors have found that as the quantization parameter increases, the chance to select a cubic filter with low smoothness as an interpolation filter increases, so that the coding efficiency is improved. Meanwhile, as a result of diligent study, the inventors have found that as the block size increases, the chance to select a Gaussian filter with high smoothness as the interpolation filter increases, so that the coding efficiency is improved.

Hereinafter, a first modification of the embodiment will be described. Differences from the embodiment will be mainly described below.

The embodiment exemplifies the case where the interpolation filter type is selected based on a combination of a block size and a quantization parameter. However, the embodiment is not limited thereto.

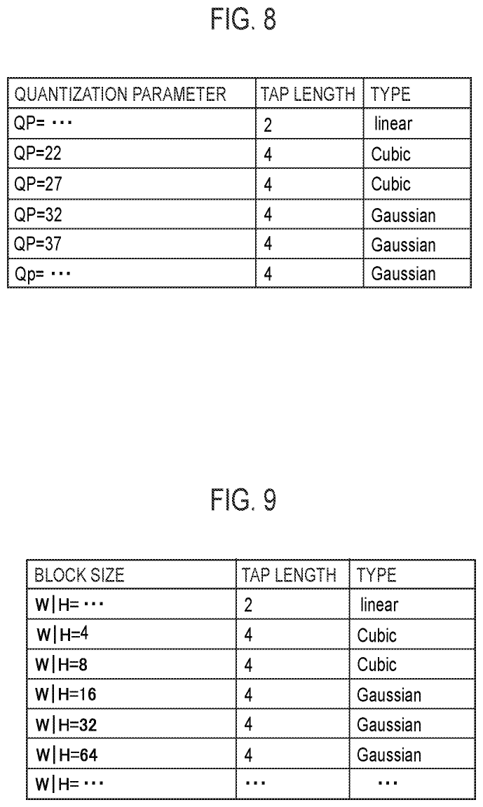

For example, as illustrated in FIG. 8, the prediction unit (filter selecting unit 112C and filter selecting unit 242C) may be configured to select an interpolation filter with higher smoothness as the quantization parameter increases. The prediction unit (filter selecting unit 112C and filter selecting unit 242C) may increase the tap length of the interpolation filter as the quantization parameter increases.

Hereinafter, a second modification of the embodiment will be described. Differences from the embodiment will be mainly described below.

The embodiment exemplifies the case where the interpolation filter type is selected based on a combination of a block size and a quantization parameter. However, the embodiment is not limited thereto.

For example, as illustrated in FIG. 9, the prediction unit (filter selecting unit 112C and filter selecting unit 242C) may be configured to select an interpolation filter with higher smoothness as the block size increases. The prediction unit (filter selecting unit 112C and filter selecting unit 242C) may increase the tap length of the interpolation filter as the block size increases.

Hereinafter, a third modification of the embodiment will be described. Differences from the embodiment will be mainly described below.

In the third modification, the prediction unit (filter selecting unit 112C and filter selecting unit 242C) may select an interpolation filter type according to an intra-prediction mode.

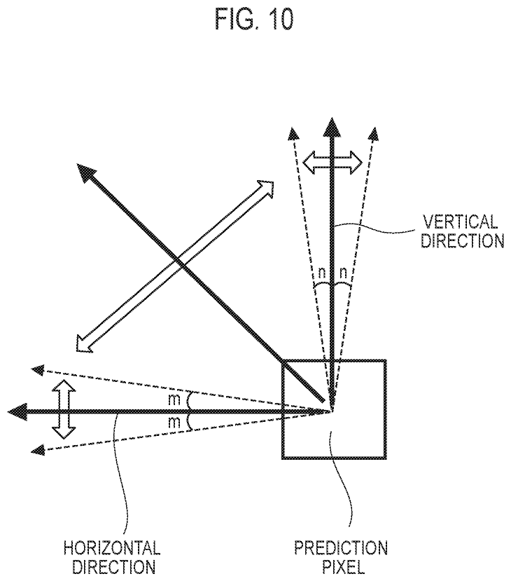

Specifically, as illustrated in FIG. 10, when the prediction direction of the intra-prediction mode has a first inclination (m in FIG. 10) or less relative to a horizontal direction, the prediction unit selects a first interpolation filter. When the prediction direction of the intra-prediction mode has a second inclination (n in FIG. 10) or less relative to a vertical direction, the prediction unit selects the first interpolation filter. m may be the same value as n or different from n. The first interpolation filter may be a cubic filter with low smoothness.

With such a configuration, when the prediction direction in the intra-prediction mode is close to the horizontal direction or the vertical direction, the prediction block is likely to include an image of intricate stripes. Consequently, by selecting the cubic filter with low smoothness, the coding efficiency can be improved.

On the other hand, when the prediction direction in the prediction mode has an inclination larger than the first inclination (m in FIG. 10) relative to the horizontal direction, the prediction unit selects a second interpolation filter as the interpolation filter. When the prediction direction in the prediction mode has an inclination larger than the second inclination (n in FIG. 10) relative to the vertical direction, the prediction unit selects the second interpolation filter as the interpolation filter. The second interpolation filter may be a Gaussian filter with high smoothness.

With such a configuration, when the prediction direction in the intra-prediction mode is far from the horizontal direction or the vertical direction, the prediction block is likely to include a flat image. Consequently, by selecting the Gaussian filter with high smoothness, the coding efficiency can be improved.

Hereinafter, a fourth modification of the embodiment will be described. Differences from the embodiment will be mainly described below.

In the fourth modification, the prediction unit (filter selecting unit 112C and filter selecting unit 242C) may select the tap length of an interpolation filter according to the position of a decimal reference pixel. The prediction unit may select a shorter tap length as the tap length of the interpolation filter as the decimal reference pixel is farther from the prediction block.

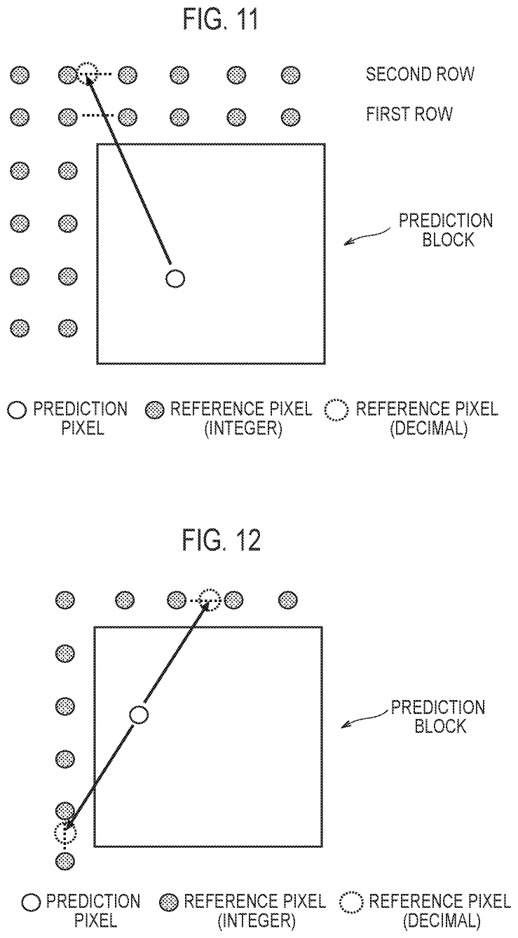

For example, as illustrated in FIG. 11, in a case where the decimal reference pixel is located in the second row from the prediction block, the tap length that is shorter than the one in a case where the decimal reference pixel is located in the first row from the prediction block may be selected as the tap length of the interpolation filter.

With such a configuration, when the decimal reference pixel is far from the prediction block, the prediction error using the decimal reference pixel increases, and thus the effect of selecting a long tap length is reduced. Consequently, the reduction in processing load processing time is prioritized.

Further, as illustrated in FIG. 12, also in a case where two or more decimal reference pixels are used, as the decimal reference pixel is farther away from the prediction block, a shorter tap length may be selected as the tap length of the interpolation filter.

Hereinafter, a fifth modification of the embodiment will be described. Differences from the embodiment will be mainly described below.

In the fifth modification, the prediction unit (filter selecting unit 112C and filter selecting unit 242C) may select an interpolation filter type depending on whether or not the reference pixel includes an edge component. Specifically, when the edge component exceeding a threshold value is present, the prediction unit may select an interpolation filter with low smoothness. When the edge component exceeding a threshold value is not present, the prediction unit may select an interpolation filter with high smoothness.

Hereinafter, a sixth modification of the embodiment will be described. Differences from the embodiment will be mainly described below.

In the sixth modification, the prediction unit (intra-prediction unit 112 and intra-prediction unit 242) includes a smoothing filter that is uniformly applied to reference pixels to which the interpolation filter has not been applied. For example, the smoothing filter is a filter with three tap lengths (¼, ½, and ¼).

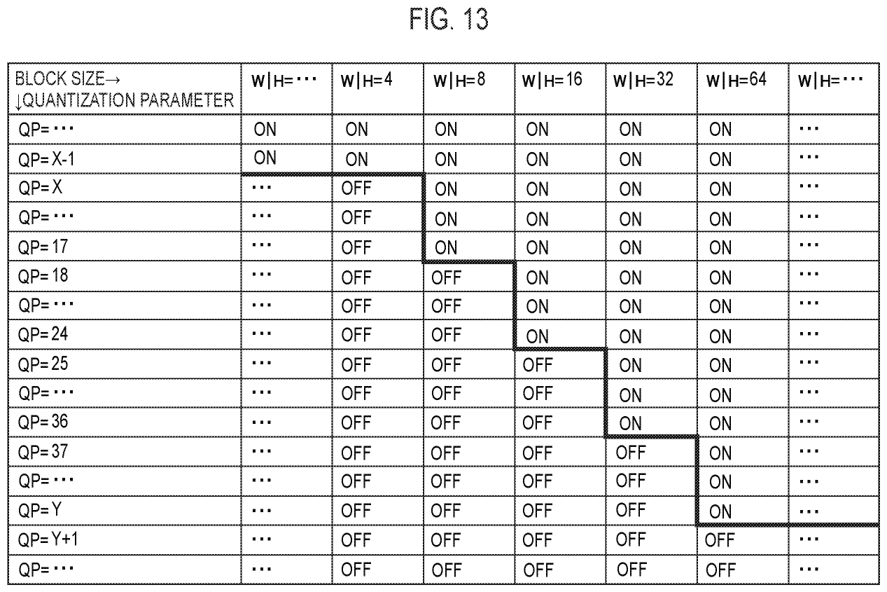

As illustrated in FIG. 13, as the quantization parameter increases, the prediction unit reduces the chance to apply a smoothing filter that is uniformly applied to the reference pixels to which the interpolation filter has not been applied. Reducing the chance means reducing the number of block sizes for which the smoothing filter is selected. As the block size increases, the prediction unit reduces the chance to apply the smoothing filter that is uniformly applied to the reference pixels to which the interpolation filter has not been applied. Reducing the chance means reducing the number of quantization parameters for which the smoothing filter is selected.

Here, the smoothing filter may be applied when the block size is larger than or equal to a threshold value (for example, eight). The smoothing filter may be applied when the block size is eight and the prediction mode is a predetermined prediction mode (planar prediction mode and diagonal prediction modes of 45°, 135°, and 225°). The smoothing filter may be applied when the block size is 16 and the prediction mode is a predetermined prediction mode (prediction mode other than DC prediction mode, horizontal prediction mode, diagonal prediction mode of ±1° from horizontal prediction mode, vertical prediction mode, and diagonal prediction mode of ±1° from vertical prediction mode). The smoothing filter may be applied when the block size is 32 and the prediction mode is a predetermined prediction mode (prediction mode other than DC prediction mode, horizontal prediction mode, and vertical prediction mode).

The block size may be the number of horizontal pixels in a prediction block, or may be the number of vertical pixels in the prediction block. The block size may be the smaller one of the number of the horizontal pixels and the number of the vertical pixels.

Here, the condition for determining the applicability of the smoothing filter in the table of FIG. 13 is linked to the condition for determining which of the interpolation filter with low smoothness and the interpolation filter with high smoothness is used in the table of FIG. 5. For example, the threshold values X and Y of FIG. 13 may be the same as the threshold values X and Y of FIG. 5.

When one of the block size and the quantization parameter satisfies a predetermined condition, the prediction unit may fix the applicability of the smoothing filter without changing the applicability. For example, the predetermined condition is at least one of the condition that the quantization parameter is smaller than a first threshold (X in FIG. 5) and the condition that the quantization parameter is larger than a second threshold (Y in FIG. 5). Specifically, when the quantization parameter is smaller than X, the prediction unit may apply the smoothing filter without depending on the block size. When the quantization parameter is larger than Y, the prediction unit does not have to apply the smoothing filter without depending on the block size.

The present invention has been described by way of the above embodiment. However, it should not be understood that the description and drawings forming a part of this disclosure limit the present invention. Various alternative embodiments, examples and operational techniques will be apparent to those skilled in the art from this disclosure.

The linear filter, the cubic filter, and the Gaussian filter are exemplified as the interpolation filter in the embodiment. However, the embodiment is not limited thereto. Any interpolation filter can be used as the interpolation filter. For example, the cubic filter is exemplified as the interpolation filter with low smoothness, but a sharpening filter such as a Laplacian filter may be used as the interpolation filter with low smoothness.

In the embodiment, the predetermined condition for determining whether or not the interpolation filter type is fixed without changing the type is the condition about the quantization parameter. However, the embodiment is not limited thereto. The predetermined condition may be the condition about the block size. For example, the predetermined condition may be at least one of the condition that the block size is smaller than a first threshold value and the condition that the block size is larger than a second threshold value.

Although not particularly mentioned in the embodiment, the quantization parameter may be a parameter that is set in units of a coded block. The quantization parameter of a target block may be set according to the quantization parameter of a coded (or decoded) adjacent block that is adjacent to the target block. When the coded (or decoded) adjacent block is not present, the quantization parameter may be set in slice units.

Although not particularly mentioned in the embodiment, the table of FIG. 5 may be used properly depending on a target frame type. The target frame type includes an I frame, a P frame, a B frame, and the like.

Although not particularly mentioned in the embodiment, the interpolation filter may be applied to a luminance signal or a color difference signal.

Although not particularly mentioned in the embodiment, the program that causes a computer to perform the processes performed by the image coding device 100 and the image decoding device 200 may be provided. In addition, the program may be recorded on a computer-readable medium. Computer-readable media can be used to install programs on a computer. Here, the computer-readable medium having the program recorded therein may be a non-transitory recording medium. The non-transitory recording medium is not particularly limited, but may be, for example, a recording medium such as a CD-ROM or a DVD-ROM.

Alternatively, it is possible to provide a chip that is composed of a memory that stores a program for executing the processes performed by the image coding device 100 and the image decoding device 200 and a processor for executing the program stored in the memory.

What is claimed is:

1. An image decoding device comprising a circuit that generates a prediction signal included in a prediction block based on a reference signal included in a reference block, wherein
the circuit comprises an interpolation filter that generates an interpolation signal of a decimal reference pixel included in the reference block from a reference signal of an integer reference pixel included in the reference block; and
the circuit selects a type of the interpolation filter based on a block size of the prediction block and a quantization parameter of the prediction block.

2. The image decoding device according to claim 1, wherein
as the quantization parameter increases, the circuit increases a chance to select an interpolation filter with low smoothness as the interpolation filter.

3. The image decoding device according to claim 1, wherein
as the block size increases, the circuit increases a chance to select an interpolation filter with high smoothness as the interpolation filter.

4. The image decoding device according to claim 1, wherein
when one of the block size and the quantization parameter satisfies a predetermined condition, the circuit fixes a type of the interpolation filter without changing the type.

5. The image decoding device according to claim 4, wherein
the predetermined condition is at least one of a condition that the quantization parameter is smaller than a first threshold and a condition that the quantization parameter is larger than a second threshold.

6. The image decoding device according to claim 1, wherein
the circuit selects the type of the interpolation filter according to a prediction mode of the prediction signal.

7. The image decoding device according to claim 6, wherein
when a prediction direction in the prediction mode has a first inclination or less relative to a horizontal direction, or when the prediction direction in the prediction mode has a second inclination or less relative to a vertical direction, the circuit selects a first interpolation filter as the interpolation filter, and
when the prediction direction in the prediction mode has an inclination larger than the first inclination relative to the horizontal direction, or when the prediction direction in the prediction mode has an inclination larger than the second inclination relative to the vertical direction, the circuit selects a second interpolation filter with higher smoothness than the first interpolation filter as the interpolation filter.

8. The image decoding device according to claim 1, wherein
the circuit selects a tap length of the interpolation filter according to a position of the decimal reference pixel.

9. The image decoding device according to claim 8, wherein
the circuit selects a shorter tap length as the tap length of the interpolation filter, as the decimal reference pixel is farther from the prediction block.

10. The image decoding device according to claim 1, wherein
as the quantization parameter increases, the circuit reduces a chance to apply a smoothing filter that is uniformly applied to a reference pixel to which the interpolation filter has not been applied.

11. The image decoding device according to claim 1, wherein
as the block size increases, the circuit reduces a chance to apply a smoothing filter that is uniformly applied to a reference pixel to which the interpolation filter has not been applied.

12. An image coding device comprising a circuit that generates a prediction signal included in a prediction block based on a reference signal included in a reference block, wherein
the circuit includes an interpolation filter that generates an interpolation signal of a decimal reference pixel included in the reference block from a reference signal of an integer reference pixel included in the reference block; and
the circuit selects a type of the interpolation filter based on a block size of the prediction block and a quantization parameter of the prediction block.

13. An image processing system comprising an image coding device and an image decoding device, wherein
the image coding device and the image decoding device include a circuit that generates a prediction signal included in a prediction block based on a reference signal included in a reference block;
the circuit includes an interpolation filter that generates an interpolation signal of a decimal reference pixel included in the reference block from a reference signal of an integer reference pixel included in the reference block; and
the circuit selects a type of the interpolation filter based on a block size of the prediction block and a quantization parameter of the prediction block.

14. A program that causes a computer to perform
a prediction step of generating a prediction signal included in a prediction block based on a reference signal included in a reference block, wherein
the prediction step includes a step of selecting an interpolation filter that generates an interpolation signal of a decimal reference pixel included in the reference block from a reference signal of an integer reference pixel included in the reference block based on a block size of the prediction block and a quantization parameter of the prediction block.
